(19) United States
(12) Patent Application Publication
(10) Pub. No.: US 2007/0223731 A1
(43) Pub. Date: Sep. 27, 2007

(54) Sound source separating device, method, and program

(75) Inventors: Masahito Togami, Kokubunji (JP); Akio Amano, Tokyo (JP); Takashi Sumiyoshi, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/700,157

(22) Filed: Jan. 31, 2007

(30) Foreign Application Priority Data
Mar. 2, 2006 (JP) 2006-055696

(51) Int. Cl. H04R 3/00; H04R 1/02

(52) U.S. Cl. 381/92; 381/122; 381/91

(57) ABSTRACT

Conventional independent component analysis has had a problem that performance deteriorates when the number of sound sources exceeds the number of microphones. Conventional l1 norm minimization method assumes that noises other than sound sources do not exist, and is problematic in that performance deteriorates in environments in which noises other than voices such as echoes and reverberations exist. The present invention considers the power of a noise component as a cost function in addition to an l1 norm used as a cost function when the l1 norm minimization method separates sounds. In the l1 norm minimization method, a cost function is defined on the assumption that voice has no relation to a time direction. However, in the present invention, a cost function is defined on the assumption that voice has a relation to a time direction, and because of its construction, a solution having a relation to a time direction is easily selected.

### CLAIM OF PRIORITY

The present application claims priority from Japanese application JP 2006-055696 filed on Mar. 2, 2006, the content of which is hereby incorporated by reference into this application.

### FIELD OF THE INVENTION

The present invention relates to a sound source separating device that separates sounds for sound sources using two or more microphones when multiple sound sources are placed in different positions, a method for the same, and a program for instructing a computer to execute the method.

### BACKGROUND OF THE INVENTION

A sound source analysis method based on independent component analysis is known as a technology for separating a sound for each of several sound sources (e.g., see A. Hyvaerinen, J. Karhunen, and E. Oja, “Independent component analysis,” John Wiley & Sons, 2001). Independent component analysis is a sound source separation technology that advantageously uses the fact that source signals of sound sources are independent between the sound sources. In the independent component analysis, linear filters having the number of dimensions equal to the number of microphones are used by the number of sound sources. When the number of sound sources is smaller than the number of microphones, it is possible to completely restore source signals. The sound source separation technology based on the independent component analysis is effective technology when the number of sound sources is smaller than the number of microphones.

In sound source separation technology, when the number of sound sources exceeds the number of microphones, the l1 norm minimization method is available which uses the fact that the probability distribution of the power spectrum of voice is close to Laplace distribution but not to a Gaussian distribution. (e.g., see P. Bofill and M. Zibulevsky, “Blind separation of more sources than mixtures using sparsity of their short-time Fourier transform,” Proc.ICA2000, pp. 87-92, 2000/06).

### SUMMARY OF THE INVENTION

The independent component analysis has a problem that performance deteriorates when the number of sound sources exceeds the number of microphones. Since the number of dimensions of a filter coefficient used in the independent component analysis is equal to the number of microphones, the number of constraints on the filter must be smaller than or equal to the number of microphones. When the number of sound sources is smaller than the number of microphones, even if there is a constraint that only a specific sound source is emphasized and all other sound sources are suppressed, since the number of constraints is at most the number of microphones, filters to satisfy the constraints can be generated. However, when the number of sound sources exceeds the number of microphones, since the number of restrictions exceeds the number of microphones, filters to satisfy the constraints cannot be generated, and signals sufficiently separated cannot be obtained using outputted filters. The l1 norm minimization method has a problem that, since it is assumed that noises other than sound sources do not exist, performance deteriorates in the environment where noises other than voices, such as echo and reverberation, exist.

The present invention for a sound source separating device or a program for executing it may include: an A/D converting unit that converts an analog signal from a microphone array including at least two microphone elements or more into a digital signal; a band splitting unit that band-splits the digital signal; an error minimum solution calculating unit that, for each of the bands, from among vectors in which sound sources exceeding the number of microphone elements have the value zero, for each of vectors that have the value zero in same elements, outputs such a solution that an error between an estimated signal calculated from the vector and a steering vector registered in advance and an input signal is minimum; an optimum model calculation part, for each of the bands, from among error minimum solutions in a group of sound sources having the value zero, selects such a solution that a weighted sum of an lp norm value and the error is minimum; and a signal synthesizing unit that converts the selected solution into a time area signal.

According to the present invention, even in an environment in which the number of sound sources exceeds the number of microphones and some background noises, echoes, and reverberations occur, with high S/N, sounds can be separated for each of sound sources. As a result, conversations are enabled in easy-to-hear sounds in hands-free conversions and the like.

### BRIEF DESCRIPTION OF THE DRAWINGS

FIG. 1 is a drawing showing a hardware configuration of the present invention;

FIG. 2 is a block diagram of software of the present invention; and

FIG. 3 is a processing flowchart of the present invention.

### DETAILED DESCRIPTION OF THE PREFERRED EMBODIMENTS

### First Embodiment

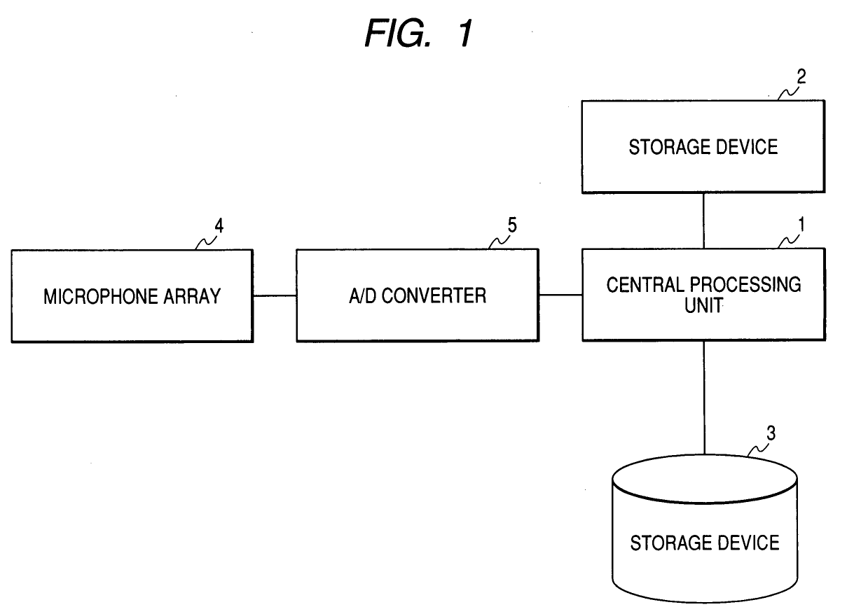

FIG. 1 shows a hardware configuration of this embodiment. All calculations included in this embodiment are performed within the central processing unit 1. A storage device 2 is a work memory constructed by a RAM, for example, and all variables used during calculations may be placed on one or more of the storage device 2. Data and programs used during calculations are stored in a storage device 3 constructed by a ROM, for example. A microphone array 4 comprises at least two or more microphone elements. The individual microphone elements measure an analog sound pressure value. It is assumed that the number of microphone elements is M.

An A/D converter converts an analog signal into a digital signal (sampling), and can synchronously sample signals of M or more channels. An analog sound pressure value of each of microphone elements captured in the microphone array 4 is sent to the A/D converter 5. The number of sounds to be separated is set in advance, and stored in the storage device 2 or 3. The number of sounds to be separated is represented as N. When N is greater, since the amount of processing becomes larger, a value suitable for the processing capacity of the central processing unit 1 is set.

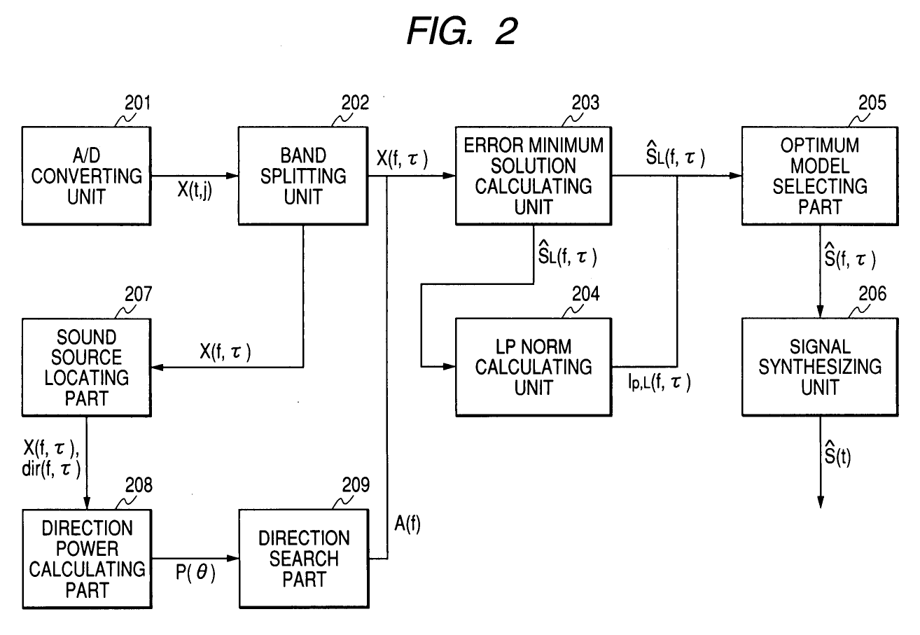

FIG. 2 shows a block diagram of software of this embodiment. In the present invention, besides l1 norm as a cost function used by the l1 norm minimization method when separating sounds, the power of a noise component contained in the separated sounds is taken into account as a cost value. An optimum model selecting part 205 in FIG. 2 outputs a minimal solution of a weighted sum of the power of the noise signal and the l1 norm value. In the l1 norm minimization method, the cost function is defined on the assumption that voices have no relation to a time direction. In the present invention, however, the cost function is defined on the assumption that voices have a relation to a time direction, and a solution having a relation to a time direction constructionally tends to be selected.

The respective units are executed in the central processing unit 1. An A/D converting unit 201 converts an analog-sound pressure value into digital data for each of the channels. Conversion into digital data in the A/D converter 5 is performed in timing of a sampling rate set in advance. For example, when the sampling rate is 11025 Hz, conversion into digital data is performed at an equal interval 11025 time per second. The converted digital data is x(t,j), where t is digitized time. When the A/D converter 5 starts A/D conversion at t=0, each time one sampling is performed, t is added one at a time. j is the number of a microphone element. For example, 100-th sampling data of a 0-th microphone element is described as x(100,0). The content of x(t,j) is written to a specified area of the RAM 2 for each sampling. As an alternative method, sampled data is temporarily stored in a buffer within the A/D converter 5, and each time a certain amount of data is stacked in the buffer, the data may be transferred to a specified area of the RAM 2. An area in the RAM 2 to which the content of x(t,j) is written is defined as x(t,j).

A band splitting unit 202 performs a Fourier transform or a wavelet analysis for data from t=π*frame_shift to t=π*frame_shift+frame_size for conversion into a band splitting signal. Conversion into a band splitting signal is made for each of microphone elements from j=1 to j=M. The converted band splitting signal is described in Expression 1 below, as a vector with signals of respective microphone elements.

X(f,π) (Expression 1)

f is an index denoting a band splitting number.

Human voices and sounds such as music rarely have large amplitude values and are sparse signals having many zero values. Therefore, voice signals can be approximated by Laplace distribution having the value of zero with high probability, not by Gaussian distribution. When a voice signal is approximated by the Laplace distribution, log likelihood can be considered as reversing the sign of l1 norm value between positive and negative. Noise signals with echo, reverberation, and background noises mixed can be approximated by a Gaussian distribution. Therefore, log likelihood of a noise signal contained in an input signal can be considered as reversing the sign of a square error between the input signal and a voice signal. In terms of MAP estimation to find the most probable solution (maximum likelihood solution), since a solution that the sum of the logarithm likelihood of a noise signal and the logarithm likelihood of a voice signal is maximized as a maximum likelihood solution, a signal that a weighted sum of a square error with the input signal and an l1 norm value is minimum can be considered as a maximum likelihood solution. However, since it is difficult to find such a solution, it is necessary to find a solution through some approximation. For example, in the l1 norm minimum method, there is no error with an input signal, and a signal that a weighted sum of l1 norm value is minimum is found as a solution. However, in the environment where echo, reverberation, and background noise exist, since it is impossible to assume that there is no error with an input signal, such an approximation becomes a rough approximation, leading to deterioration of separation capability.

Accordingly, in the present invention, on the assumption that an error with an input signal exists, a weighted sum of a square error with the input signal and the l1 norm value at minimum is approximated. As described previously, human voices and sounds such as music are sparse signals rarely having large amplitude values. In short, they are considered as signals that often have an approximate zero amplitude (the “value zero”). Accordingly, for each time and frequency, only sound sources fewer than the number of microphones are assumed to have amplitude values other than the value zero. The l1 norm value becomes smaller as the number of elements having the value zero increases, and becomes larger as the number of elements having the value zero decreases. Therefore, it can be considered as a measure of sparseness (see Noboru Murata, “Introductory Independent Component Analysis,” Tokyo Electricians' University Publications Service, pp. 215-216, 2004/07).

Accordingly, when the number of sound sources having the value zero is equal to the number of microphones, the l1 norm value is approximated to a fixed value. If this approximation is applied when the number of sound sources is N (of N-dimensional complex vectors that have the value zero), a solution may be presented having the smallest error with an input signal.

An error minimum solution calculating unit 203, calculates according to

$${\hat{S}}_{L} ( f , τ ) = {arg min}_{{S ( f , τ ) ∈ L -}_{dimensional sparse set}} {\vert X ( f , τ ) - A ( f ) S ( f , τ ) \vert}^{2} \qquad ( Expression 2 )$$

For each of L-dimensional sparse sets, an error minimum solution is calculated. An L-dimensional sparse set is an N-dimensional complex vector having L elements of the value zero. A calculated solution with the smallest error is a maximum likelihood solution of each sound source signal in the L-dimensional sparse set. The solution with the smallest error is an N-dimensional complex vector. The respective elements are estimated values of source signals of respective sound sources. A(f) is an M-by-N complex matrix that has sound propagations (steering vector) from respective sound source positions to microphone elements in columns. For example, the first column of A(f) is a steering vector from a first sound source to a microphone array. A(f) is calculated and outputted by a direction search part 209 in FIG. 2. The error minimum solution calculating unit 203 in FIG. 2 calculates an error minimum solution for each L of Ls from 1 to M. When L=M, multiple error minimum solutions are calculated, in which case all the multiple solutions are outputted as error minimum solutions of L=M. In this example, for each of N-dimensional complex vectors having elements equal to the number of sound sources having the value zero, an error minimum solution has been found. However, without being limited to the number of sound sources, for each of N-dimensional vectors having elements equal to the number elements having the value zero, a solution may be found. However, even when the number of elements having the value zero is not equal, if the number of sound sources is equal, since the l1 norm value can be approximated to a fixed value, the number of sound sources having the value zero, it is sufficient to find an error minimum solution.

Instead of the above-described expression 2, expression 3 can also be applied.

$${\hat{S}}_{L , j} ( f , τ ) = {arg min}_{S ( f , τ ) ∈ {Ω}_{L , j}} {\vert X ( f , τ ) - A ( f ) S ( f , τ ) \vert}^{2} \\ {error}_{L , j} ( f , τ ) = ‖ X ( f , τ ) - A ( f ) {S ( f , τ ‖}^{2} \\ {j}_{min} = {arg min}_{j} {\sum }_{m = - k}^{k} γ ( m ) {error}_{L , j} ( f , τ + m ) \\ {\hat{S}}_{L} ( f , τ ) = {\hat{S}}_{L , {j}_{min}} ( f , τ ) \qquad ( Expression 3 )$$

ΩL,j is an N-dimensional complex vector set in which the value of same elements is zero, of L-dimensional sparse sets. The power of voice has a positive correlation in a time direction. Therefore, a sound source having a large value in a given π will probably have a large value even in π±k as well. This means that a smaller moving average in π direction of the error term can be considered as a solution closer to a true solution. In other words, for each model ΩL,j, by using the moving average of an error item as a new error item, a solution closer to a true solution can be found. γ(m) is a weight of the moving average. By this construction, a solution having a relation to a time direction is easily selected. When an error minimum solution is found by using the moving average, for each of N-dimensional complex vectors equal in terms of elements in addition to the number of sound sources of the value zero, an error minimum solution must be calculated. This is because even when the number of sound sources is equal, if elements are different, approximation cannot be performed as having a positive correlation in a time direction.

An lp norm calculating unit 204 in FIG. 2 calculates an lp norm value by an expression below, based on an error minimum solution calculated by each L-dimensional sparse set:

$$\begin{matrix}{l}_{p , L} ( f , τ ) = {( {\sum }_{i = 1}^{N} {\vert {\hat{S}}_{L , i} ( f , τ ) \vert}^{p} )}^{\frac{1}{p}} & ( Expression 4 ) \\ {\hat{S}}_{L , i} ( f , τ ) & ( Expression 5 ) \\ {\hat{S}}_{L} ( f , τ ) & ( Expression 6 )\end{matrix}$$

Expression 5 is i-th element of expression 6.

Variable p is a parameter previously set between 0 and 1. The lp norm value is a measure of sparse degree of Expression 6 (see Noboru Murata, “Introductory Independent Component Analysis,” Tokyo Electricians' University Publications Service, pp. 215-216, 2004/07), and is smaller when there are more elements close to zero in Expression 6. Since voice is sparse, when the value of Expression 4 is smaller, Expression 6 can be considered to be closer to a true solution. In short, Expression 4 can be used as a selection criterion when a true solution is selected.

A calculated value of lp norm of Expression 4 may be replaced by a moving average like the calculation of an error minimum solution:

$$avg - {l}_{p , L} ( f , τ ) = {\sum }_{m = - k}^{k} γ ( m ) {( {\sum }_{i = 1}^{N} {\vert {\hat{S}}_{L , j min i} , ( f , τ + m ) \vert}^{p} )}^{\frac{1}{p}} \qquad ( Expression 7 )$$

Since the power of voice has a positive correlation in time direction, by replacing it by a moving average, a solution close to a true solution can be found. The power of voice changes only slightly in time direction. Therefore, a sound source having a large amplitude value in a certain frame can be considered to have large amplitude values also in frames adjacent to the frame. An optimum model selecting part 205 in FIG. 2 finds an optimum solution of error minimum solutions found for each of respective L-dimensional sparse sets by;

$$\begin{matrix}{L}_{min} = {arg min}_{L} α {‖ X ( f , τ ) - A ( f ) S ( f , τ ) ‖}^{2} + {l}_{p , L} ( f , τ ) & ( Expression 8 ) \\ \hat{S} ( f , τ ) = {\hat{S}}_{{L}_{min}} ( f , τ ) & ( Expression 9 )\end{matrix}$$

Expression 8 and Expression 9 output a solution so that a weighted mean value of an error term and an lp norm item is minimum. This solution is a post probability maximum solution. To find an optimum solution, like an error minimum solution and an l1 norm minimum solution, Expression 8 and Expression 9 can be replaced by a moving average value:

$${L}_{min} = {arg min}_{L} α {error}_{L} ( f , τ ) + avg - {l}_{p , L} ( f , τ ) \\ \hat{S} ( f , τ ) = {\hat{S}}_{{L}_{min}} ( f , τ ) \qquad ( Expression 10 )$$

According to a conventional method, in processing corresponding to the optimum model selecting part 205, solutions from L=2 . . . M are not selected and a solution of L=1 is an optimum solution. This method has had the problem of causing noise. In a solution of L=1, for each of f and π, except one sound source, all values are zeros. At some times, except one sound source, a solution with all values close to zero may exist. When it is satisfied, a solution of L=1 becomes an optimum solution, but it is not always satisfied. If L=1 is always assumed, when two or more sound sources have large values, no solution can be found and musical noises occur. The optimum model selecting part 205, to find an optimum solution from among error minimum solutions found for each L-dimensional sparse set, determines which sparse set is optimum for L from 1 to M, and can find a solution even when the values of two or more sound sources are greater than zero, suppressing the occurrence of musical noises.

A signal synthesizing unit 206 in FIG. 2 subjects an optimum solution calculated for each band

Ŝ(f,π) (Expression 11)

to reverse Fourier transform or reverse-wavelet transform to return to a time area signal (Expression 12).

Ŝ(f,π) (Expression 12)

By doing so, an estimated signal of a time area of each sound source can be obtained. A sound source locating part 207 in FIG. 2 calculates a sound source direction, based on

$$dir ( f , τ ) = {arg max}_{θ ∈ Ω} {\vert {a}_{θ}^{*} ( f , τ ) X ( f , τ ) \vert}^{2} \qquad ( Expression 13 )$$

Ω is a search range of sound sources, and is previously set in the ROM 3.

a_{θ}(f,π) (Expression 14)

Expression 14 is a steering vector from sound source direction θ to the microphone array, and its size is normalized to one. When a source signal is s(f,π), a sound arriving from the sound source direction θ is observed in the microphone array by Expression 15:

X_{θ}(f,π)=s(f,π)a_{θ}(f,θ) (Expression 15)

Ω of all sound sources included in Expression 13 is stored in advance in the ROM 3. A direction power calculating part 208 in FIG. 2 calculates sound source power in each direction by Expression 16.

$$P ( θ ) = {\sum }_{f} {\sum }_{τ = 0}^{K} δ ( θ = dir ( f , τ ) ) log {\vert {a}_{θ}^{*} ( f , τ ) X ( f , τ ) \vert}^{2} \qquad ( Expression 16 )$$

δ is a function that becomes one only when the equation of an argument is satisfied, and zero when not satisfied. The direction search part 209 in FIG. 2 peak-searches P(θ) to calculate sound source directions, and outputs an M-by-N steering vector matrix A(f) that has steering vectors of sound source directions in columns. The peak search arranges P(θ) in descending order, and may calculate N high-order sound source directions, or N high-order sound source directions when P(θ) exceeds the back and forth directions (when it becomes a maximum value). The error minimum solution calculating unit 203 uses the information as A(f) in Expression 2 to find an error minimum solution. The direction search part 209 searches A(f) to automatically estimate a sound direction even when a sound source direction is unknown, enabling sound source separation.

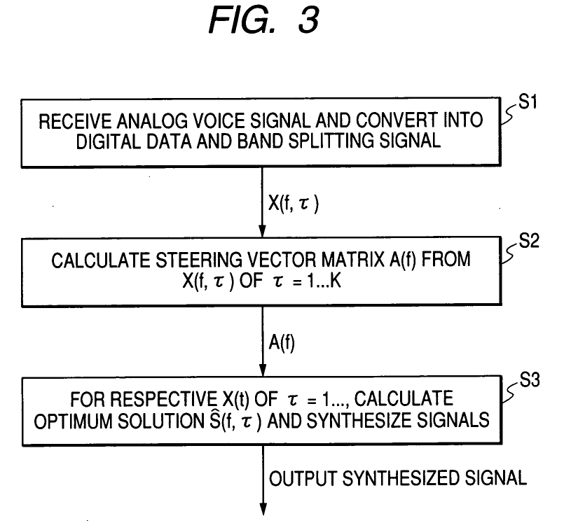

FIG. 3 shows a processing flow of this embodiment. An inputted voice is received as a sound pressure value in respective microphone elements. The sound pressure values of respective microphone elements are converted into digital data. Band splitting processing of frame_size is performed while shifting data for each frame_shift (S1). Only π=1 . . . k of obtained band splitting signals are used to estimate sound source directions, and a steering vector matrix A(f) is calculated (S2).

A(f) is used to search for true solutions of band splitting signals of π=1 . . . . The obtained optimum solutions are synthesized to obtain an estimated signal for each sound source (S3). An estimated signal of each sound source synthesized in (S3) is an output signal. The output signal is a signal that a sound is separated for each of sound sources, and produces a sound easy to understand the contents of utterance of each sound source.

What is claimed is:

1. A sound source separating device, comprising:
an A/D converting unit that converts an analog signal, from a microphone array having number M microphones, wherein M includes at least two microphones, into a digital signal;
a band splitting unit that band-splits the digital signal for conversion to a frequency domain input;
an error minimum solution calculating unit that, for each of the bands, has vectors for sound sources exceeding the number M, and has vectors for sound sources that are from 1 to equal to the number M, and that outputs a solution set having minimized error between an estimated signal calculated from the vectors for sound sources 1 to M, a predetermined steering vector, and the frequency domain input;
an optimum model calculation part that, for each of the bands in the error minimized solution set, selects a frequency domain solution having a weighted sum of an lp norm value and the error that is minimized; and
a signal synthesizing unit that converts the selected frequency domain solution into time domain.

2. The sound source separating device according to claim 1,
wherein the steering vector is obtained by performing source location.

3. The sound source separating device according to claim 1,
wherein the error minimum solution calculating unit calculates a solution with a minimum error for each of the vectors that are equal in number of sound sources to the value zero and number of elements to the value zero, and
wherein the optimum model calculation part, from among the outputted error minimum solution set, selects a solution having a weighted sum of a moving average value of the error and the moving average value of lp norm.

4. The sound source separating device according to claim 3,
wherein the error minimum solution calculating unit calculates a solution with a minimum error for each of the vectors that are equal in the number of sound sources to the value zero and the number of elements to the value zero, and
wherein the optimum model calculation part, from among the outputted error minimum solution set, selects a solution having a weighted sum of the moving average value of the error and the moving average value of lp norm at a minimum.

5. A sound source separating program, comprising the steps of:
converting an analog signal from a microphone array including M microphones, wherein M is greater than or equal to 2, into a digital signal;
band-splitting the digital signal into frequency domain;
for each of the bands split, and from among vectors in which sound sources exceeding the number of microphone elements have value zero, and for each vector having sound sources of a number of elements between 1 and M, outputting a solution set having a minimum error between an estimated signal calculated from the vector, a steering vector, and the frequency domain signal;
for each of the bands split, and from among error minimum solution set, selecting a solution for which a weighted sum of an lp norm value and the error is minimum; and
converting the selected solution into time domain.

6. A method for sound source separation, comprising:
receiving, at M microphones, an analog sound input;
converting the analog sound input from at least two sound sources to a digital sound input;
converting the digital sound input from a time domain to a frequency domain;
generating a first solution set minimizing errors in an estimation of sound from active ones of the sound sources of number 1 to M;
estimating a number of sound sources active to generate an optimal separated solution set that most closely approximates each sound source of the received analog sound input in accordance with the first solution set; and
converting the optimal separated solution set to the time domain.
